(19) United States
(12) Patent Application Publication
(10) Pub. No.: US 2006/0083330 A1
(43) Pub. Date: Apr. 20, 2006

(54) Distortion compensation table creation method and distortion compensation method

(75) Inventors: Hideo Nagata, Ogasa-gun (JP); Takashi Enoki, Yokohama-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD.

(21) Appl. No.: 10/537,909

(22) PCT Filed: Dec. 17, 2003
(86) PCT No.: PCT/JP03/16140

§ 371 Date: Jun. 8, 2005

(30) Foreign Application Priority Data
Dec. 17, 2002 (JP) 2002-365448

(51) Int. Cl. H04L 25/49

(52) U.S. Cl. 375/297

(57) ABSTRACT

Fundamentals and IM waves comprising distortion signals are detected by vector measurement from an amplified baseband signal. Detected IM waves are related to power and frequency and plotted on the frequency axis. IM waves related to power and frequency are subjected to IFFT processing, and thereby converted so as to be related to time and power. Amplitude and phase components of IM waves subjected to IFFT processing are found. Compensation signal generation information is generated by relating a distortion compensation signal that has amplitude components of inverse amplitude to the amplitude components of IM waves and phase components of inverse phase to the phase components of IM waves to power, and creating a table by storing the generated compensation signal generation information in a compensation table. By this means, the circuit configuration can be made small and simple, processing can be simplified and speeded up, and distortion components can be suppressed with high precision.

### TECHNICAL FIELD

The present invention relates to a distortion compensation table creation method and distortion compensation method, and, for example, to a distortion compensation table creation method and distortion compensation method that eliminate distortion generated when a signal is amplified.

### BACKGROUND ART

Heretofore a predistortion distortion compensation apparatus has been known as an apparatus that compensates for distortion generated when a transmit signal is amplified in a radio communication apparatus. FIG. 1 is a block diagram showing the configuration of a conventional predistortion distortion compensation apparatus 100.

Conventional predistortion distortion compensation apparatus 100 is composed of a baseband I input terminal 101, a baseband Q input terminal 102, a power calculation section 103, a compensation data table 104, a complex multiplication section 105, a digital/analog converter (hereinafter referred to as “DAC”) 106, a DAC 107, a modulator (hereinafter referred to as “MOD”) 108, an oscillator 109, a power amplifier 110, a directional coupler 111, an RF output terminal 112, a demodulator (hereinafter referred to as “DEMOD”) 113, an analog/digital converter (hereinafter referred to as “ADC”) 114, an ADC 115, a compensation data computation section 116, and a delay section 117.

In FIG. 1, a baseband I signal is input to baseband I input terminal 101 and a baseband Q signal that is orthogonal data with respect to the I signal is input to baseband Q input terminal 102, and these signals pass through DAC 106 and DAC 107, and are modulated to RF signals by MOD 108. The signal modulated to RF then undergoes power amplification by power amplifier 110 and is output from RF output terminal 112.

At this time, since power amplifier 110 performs nonlinear operation, distortion is generated in the signal amplified by power amplifier 110. A predistortion function is a function for amending the nonlinearity of power amplifier 110 to linearity. In order to perform power amplifier 110 linearity compensation, compensation data table 104 is provided with compensation data corresponding to power values. Power calculation section 103 performs input baseband signal power calculation every sampling time and outputs the result to compensation data table 104. Compensation data table 104 is referenced using the power calculation result input from power calculation section 103, and the necessary compensation data is extracted and output to complex multiplication section 105. Complex multiplication section 105 operates so as to suppress distortion generated in power amplifier 110 for the input I signal and Q signal.

In order to perform accurate linearity compensation, accuracy of compensation data table 104 is required. Therefore, conventionally, a power amplifier 110 output signal is taken from directional coupler 111, processing is performed by compensation data computation section 116 to calculate a distortion component of a signal demodulated by DEMOD 113 corresponding to a baseband signal prior to amplification, and a compensation data table is created to compensate for the calculated distortion component. By this means, an accurate compensation data table can be created.

However, a problem with a conventional distortion compensation table creation method and distortion compensation method is that DEMOD 113 and compensation data computation section 116 are necessary for compensation data table 104 generation, resulting in a large and complex circuit configuration. A further problem with a conventional distortion compensation table creation method and distortion compensation method is that, since it is necessary to perform demodulation processing in DEMOD 113 and computational processing to find compensation data in compensation data computation section 116, processing is complex and cannot be executed at high speed.

### DISCLOSURE OF INVENTION

It is an object of the present invention to provide a distortion compensation table creation method and distortion compensation method that enable a small and simple circuit configuration to be used, enable processing to be simplified and speeded up, and also enable distortion components to be suppressed with high precision.

This object can be achieved by finding a distortion component generated when a baseband signal is amplified by relating frequency to baseband signal power, converting the distortion component found by relating frequency to power so as to be related to time and power, and also finding an amplitude component and phase component in a distortion component converted so as to be related to time and power for each power, and relating a distortion compensation signal that has a found amplitude component of inverse amplitude to the amplitude component and a found phase component of inverse phase to the phase component to power, and performing storage in a table as compensation signal generation information for selecting a distortion compensation signal that suppresses distortion components.

### BRIEF DESCRIPTION OF DRAWINGS

FIG. 1 is a block diagram showing the configuration of a conventional distortion compensation apparatus;

FIG. 2 is a block diagram showing the configuration of a transmitting apparatus according to Embodiment 1 of the present invention;

FIG. 3 is a flowchart showing a compensation data table creation method according to Embodiment 1 of the present invention;

FIG. 4 is a drawing showing on the frequency axis a two-wave signal input to an amplifier according to Embodiment 1 of the present invention;

FIG. 5 is a drawing showing on the frequency axis a signal output from an amplifier according to Embodiment 1 of the present invention;

FIG. 6 is a drawing showing on the time axis the power values of a signal output from an amplifier according to Embodiment 1 of the present invention;

FIG. 7 is a drawing showing by means of the relationship between compensation data power and amplitude the nonlinear characteristic of an amplifier according to Embodiment 1 of the present invention;

FIG. 8 is a drawing showing by means of the relationship between compensation data power and phase the nonlinear characteristic of an amplifier according to Embodiment 1 of the present invention;

FIG. 9 is a block diagram showing the configuration of a transmitting apparatus according to Embodiment 2 of the present invention;

FIG. 10 is a drawing showing on the frequency axis a signal output from an amplifier according to Embodiment 2 of the present invention;

FIG. 11 is a drawing showing on the time axis the power values of a signal output from an amplifier for creating a compensation data table according to Embodiment 2 of the present invention;

FIG. 12 is a drawing showing by means of the relationship between compensation data power and amplitude the nonlinear characteristic of an amplifier according to Embodiment 2 of the present invention;

FIG. 13 is a drawing showing by means of the relationship between compensation data power and phase the nonlinear characteristic of an amplifier according to Embodiment 2 of the present invention;

FIG. 14 is a drawing showing by means of the relationship between compensation data power and amplitude the nonlinear characteristic of an amplifier according to Embodiment 2 of the present invention;

FIG. 15 is a drawing showing by means of the relationship between compensation data power and phase the nonlinear characteristic of an amplifier according to Embodiment 2 of the present invention;

FIG. 16 is a block diagram showing the configuration of a transmitting apparatus according to Embodiment 3 of the present invention;

FIG. 17 is a drawing showing the relationship between amplitude and power when account is not taken of hysteresis of a signal output from an amplifier according to Embodiment 3 of the present invention;

FIG. 18 is a drawing showing the relationship between phase and power when account is not taken of hysteresis of a signal output from an amplifier according to Embodiment 3 of the present invention;

FIG. 19 is a drawing showing the relationship between power and amplitude when account is taken of hysteresis of a signal output from an amplifier according to Embodiment 3 of the present invention;

FIG. 20 is a drawing showing the relationship between power and phase when account is taken of hysteresis of a signal output from an amplifier according to Embodiment 3 of the present invention;

FIG. 21 is a drawing showing the relationship between power and amplitude in a compensation signal according to Embodiment 3 of the present invention;

FIG. 22 is a drawing showing the relationship between power and phase in a compensation signal according to Embodiment 3 of the present invention;

FIG. 23 is a drawing showing the relationship between power and amplitude in a compensation signal according to Embodiment 3 of the present invention; and

FIG. 24 is a drawing showing the relationship between power and phase in a compensation signal according to Embodiment 3 of the present invention.

### BEST MODE FOR CARRYING OUT THE INVENTION

With reference now to the accompanying drawings, embodiments of the present invention will be explained in detail below.

### Embodiment 1

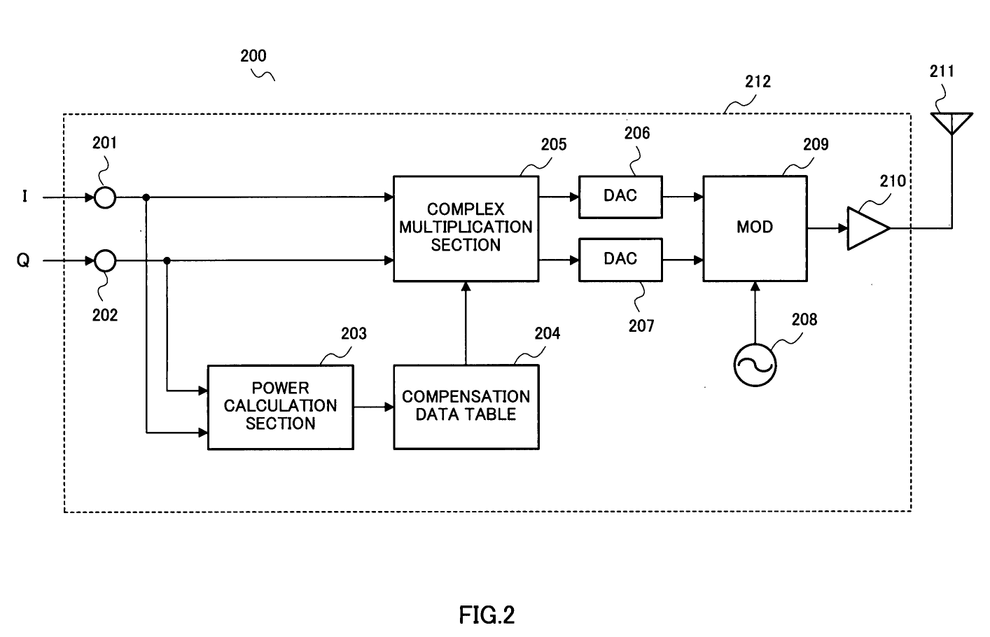

FIG. 2 is a block diagram showing the configuration of a transmitting apparatus 200 according to Embodiment 1 of the present invention. In FIG. 2, transmitting apparatus 200 is mainly composed of an input terminal 201, an input terminal 202, a power calculation section 203, a compensation data table 204, a complex multiplication section 205, a DAC 206, a DAC 207, an oscillator 208, a MOD 209, an amplifier 210, and an antenna 211.

Input terminals 201 and 202, power calculation section 203, compensation data table 204, complex multiplication section 205, DAC 206, DAC 207, oscillator 208, MOD 209, and amplifier 210 make up a distortion compensation apparatus 212. For distortion compensation apparatus 212 in FIG. 2, a predistortion distortion compensation apparatus configuration is shown, with power calculation section 203, compensation data table 204, and complex multiplication section 205 forming a predistortion function.

Input terminal 201 receives an I component baseband signal and sends this signal to power calculation section 203 and complex multiplication section 205.

Input terminal 202 receives a Q component baseband signal and sends this signal to power calculation section 203 and complex multiplication section 205.

Power calculation section 203 performs power calculations for baseband signals input from input terminal 201 and input terminal 202 every sampling time, and outputs measured power information, which is calculated power information, to compensation data table 204.

Compensation data table 204 is a data table for performing linear compensation of the amplifier, which has nonlinear characteristics, and holds vector value information. Compensation data table 204 outputs a compensation signal comprising compensation signal generation information, in which amplitude component and phase component compensation information selected using measured power information input from power calculation section 203 is held as a vector value, to complex multiplication section 205. The method of creating the compensation table held by compensation data table 204 will be described later herein.

Complex multiplication section 205 suppresses IM waves comprising baseband signal distortion components based on the baseband signals input from input terminal 201 and input terminal 202 and the compensation signal input from compensation data table 204, and outputs the resulting signals to DAC 206 and DAC 207.

DAC 206 converts the baseband signal input from complex multiplication section 205 from analog data to digital data, and outputs this digital data to MOD 209.

DAC 207 converts the baseband signal input from complex multiplication section 205 from analog data format to digital data format and generates a digital converted signal, and outputs this signal to MOD 209.

Oscillator 208 is a local oscillator that outputs a predetermined frequency signal to MOD 209.

MOD 209 modulates digital converted signals input from DAC 206 and DAC 207 using a signal input from oscillator 208 and generates a modulated signal, and outputs this modulated signal to amplifier 210.

Amplifier 210 amplifies the modulated signal input from MOD 209 and sends the amplified signal to antenna 211.

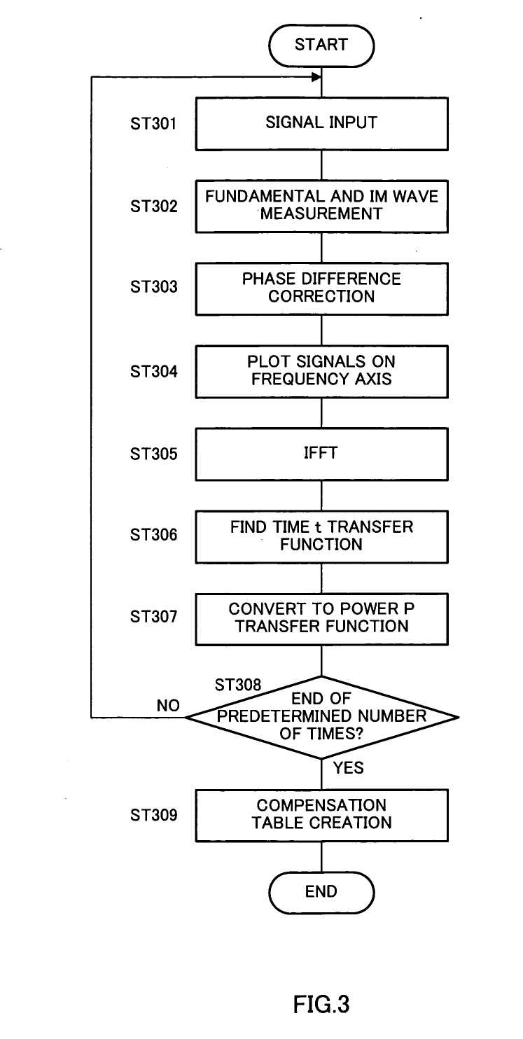

Next, the method of creating the compensation table held by compensation data table 204 will be described using FIG. 3 through FIG. 8. The compensation table is created before a distortion component suppression operation.

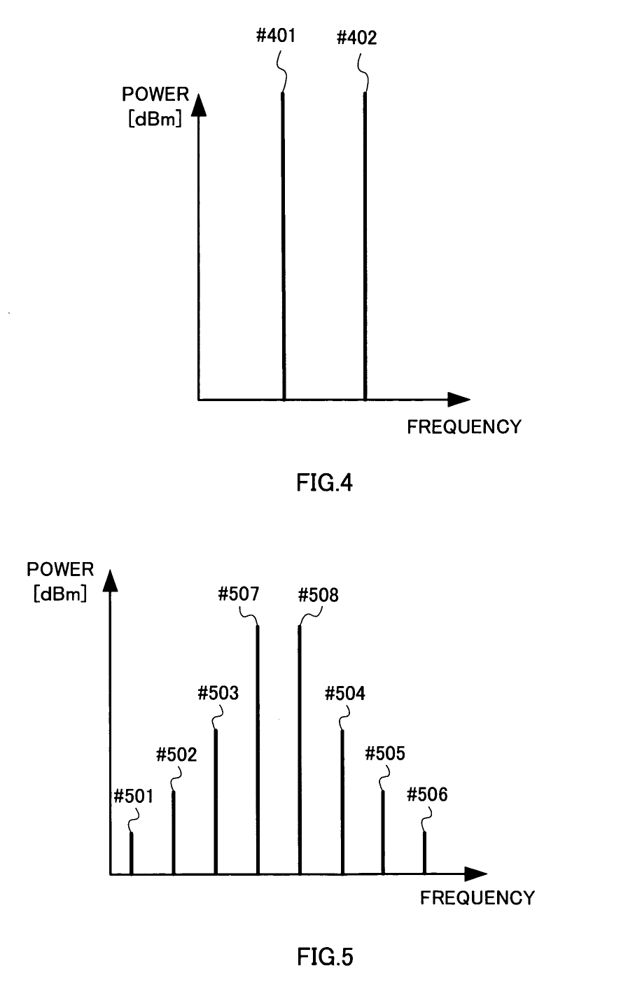

First, as shown in FIG. 4, a two-wave signal comprising two waves (two tones), fundamental #401 and fundamental #402, is input to amplifier 210 (step ST301) Next, the input two-wave signal is amplified by amplifier 210, and the fundamentals and IM waves in the amplified two-wave signal undergo vector measurement by means of a vector signal analyzer (step ST302). By this means, the fundamentals and IM waves can be obtained as vector values on the frequency axis, and can be obtained not only as power values (amplitude values) but also as phase values. Vector measurement can be carried out by any method, not only by using a vector signal analyzer.

Next, based on the measurement results, the fundamental phase difference of the two-wave signal is corrected so that the fundamental phase difference becomes 0 degrees, and IM wave phase correction is carried out in accordance with the amount of fundamental phase correction (step ST303). Also, correction is performed so that the phase difference of the input two-wave signal becomes 0 degrees (step ST303).

Then, as shown in FIG. 5, fundamentals and IM waves reflecting these corrections are plotted as a frequency axis series (f-dat-out) (step ST304). By amplifying the input two-wave signal, IM waves #501, #502, #503, #504, #505, and #506 are generated in addition to fundamentals #507 and #508. IM waves #501, #502, #503, #504, #505, and #506 are generated as distortion components of fundamentals #507 and #508, and the further these IM waves are from fundamentals #507 and #508 on the frequency axis, the smaller is their power. Plotting is also performed as a frequency axis series (f-dat-in) for an input two-wave signal subjected to phase correction (step ST304).

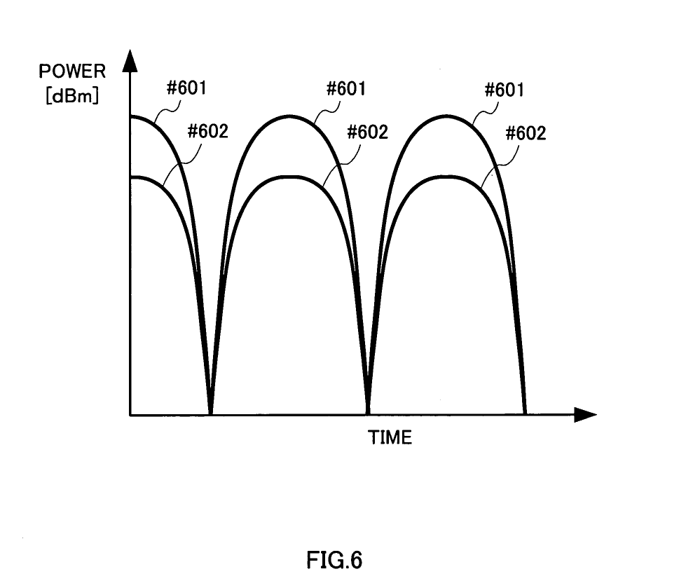

Next, IM waves #501, #502, #503, #504, #505, and #506 plotted as frequency axis series (f-dat-out) are subjected to inverse fast Fourier transform (hereinafter referred to as “IFFT”) processing, and converted to a time axis series (t-dat-out) (step ST305). Also, the two-wave signal plotted as a frequency axis series is subjected to IFFT processing and converted to a time axis series (t-dat-in) (step ST305). FIG. 6 shows an output signal #601 and input signal #602 converted to a time axis series as power values.

Then, using Equation (1) the amplifier 210 transfer function is obtained from the obtained amplifier input signal and output signal frequency axis series (step ST306).
AMP(t)=(t-dat-out)/(t-dat-in) (1)
where

AMP(t): Amplifier 210 transfer function

(t-dat-out): Time axis series

(t-dat-in): Frequency axis series

Amplifier transfer function AMP(t) expressed by a time function is converted to input signal power function AMP(P) using Equation (2) (step ST307).
P=abs(t-dat-in) (2)
where

P: Input signal power

abs(t-dat-in): Root-mean-square value

It is then determined whether or not the predetermined number of measurements by means of the vector signal analyzer have finished (step ST308). If the predetermined number of measurements have finished, the measurement results are combined and transfer function AMP(P) is found.

Here, the compensation table stored by compensation data table 204 is stored as vector information, and the vector information has both amplitude and phase information. Therefore, compensation data table 204 has amplitude and phase components corresponding to power P input to amplifier 210 as a compensation data table. That is to say, the relationship between an input signal to amplifier 210 and an output signal from amplifier 210 is expressed as shown in Equation (3).
Output signal=AMP(P)×input signal (3)
where AMP(P): Amplifier 210 transfer function

Also, amplifier transfer function AMP(P) is expressed as shown in Equation (4).
AMP(P)=A(P)×e^{-jθ(P)} (4)
where

P: Input power

A(P): Amplitude component

θ(P): Phase component

The meaning of nonlinearity taken to be a problem here is that amplification characteristic A(P) and phase characteristic θ(P) fluctuate. Compensation to linearity means compensation to a fixed-power amplifier 210 transfer function. Therefore, the compensation signal can be expressed as a power P function as shown in Equation (5).
Compensation signal (P)=AMP(fixed)/AMP(P) (5)
where

AMP(fixed): Fixed-power amplifier 210 transfer function

AMP(P): Amplifier 210 transfer function

Thus, amplifier 210 transfer function AMP(P) can be found using Equation (5).

Next, a transfer function is found that has an amplitude component of inverse amplitude to the amplitude component in the amplifier 210 transfer function found from Equation (5) and a phase component of inverse phase to the phase component in the amplifier 210 transfer function found from Equation (5) with respect to an amplitude component and phase component when the amplifier 210 output signal has a linear characteristic, and the found transfer function is converted and stored as a compensation table (step ST309).

On the other hand, if the predetermined number of measurements have not finished in step ST308, the processing from step ST301 through step ST307 is repeated until the predetermined number of measurements have finished.

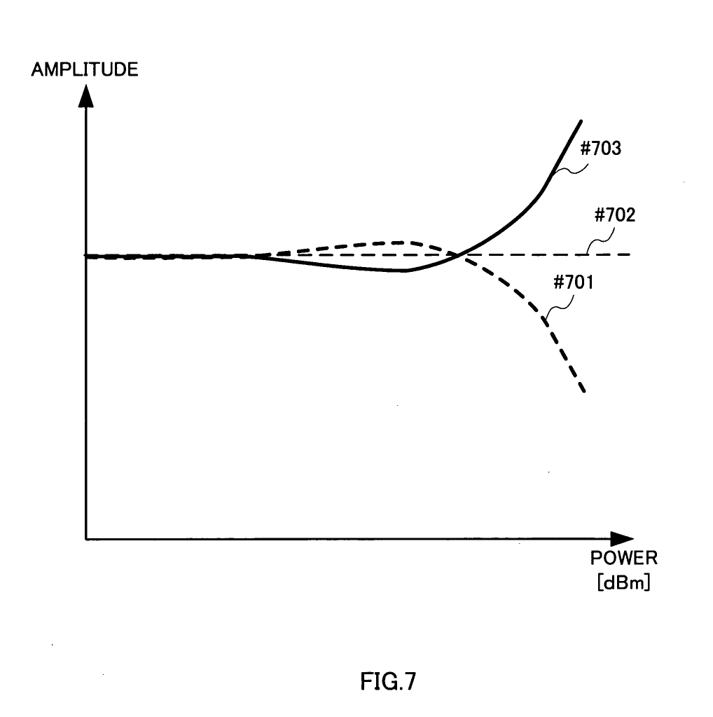

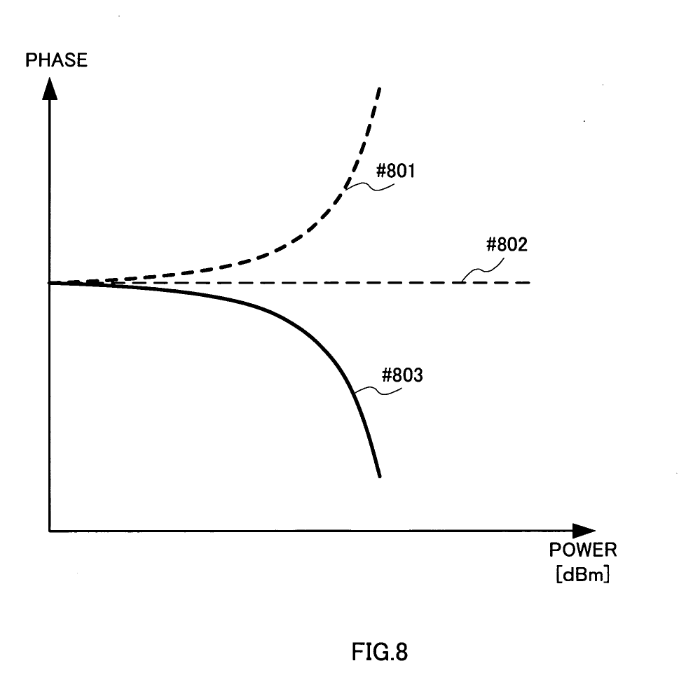

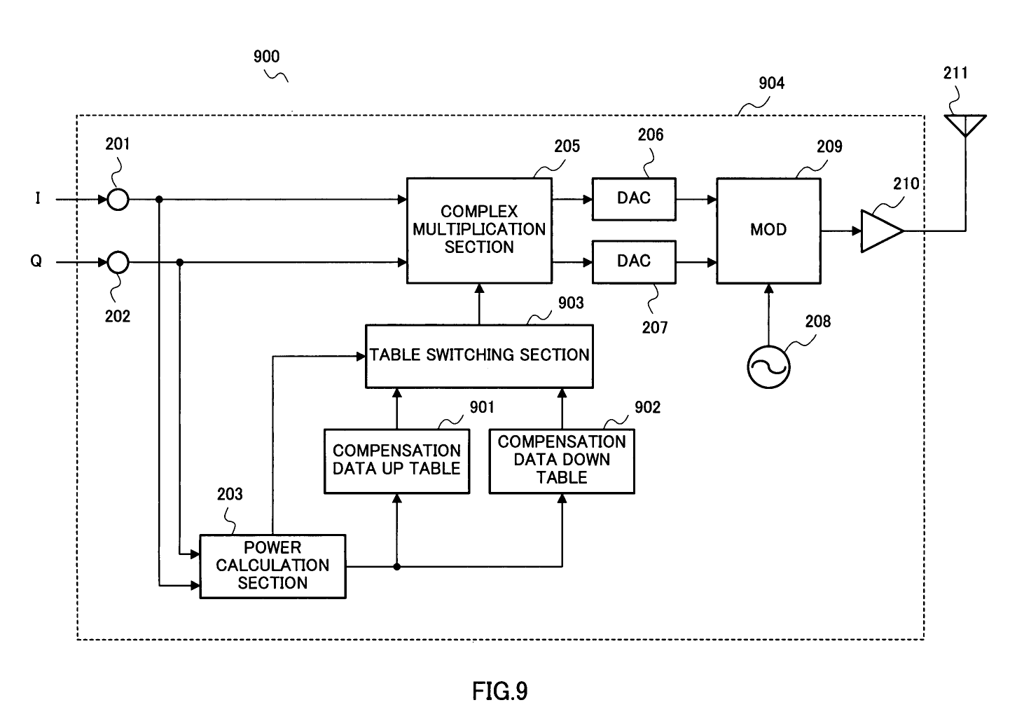

FIG. 7 is a drawing showing the relationship between compensation data power and amplitude in the compensation table, and FIG. 8 is a drawing showing the relationship between compensation data power and phase in the compensation table. FIG. 7 shows a case where, with regard to the relationship #702 between amplitude and power, amplifier 210 has linearity, and since amplifier 210 is actually nonlinear, it has the nonlinear characteristic of relationship #701 between amplitude and power. Therefore, compensation data table 204 stores, as compensation data, relationship #703 between amplitude and power symmetrical with relationship #701 between amplitude and power that the actual signal after amplitude has with respect to relationship #702 between an amplitude component and power when amplifier 210 has linearity. By this means, compensation data amplitude components become amplitude components of inverse amplitude to the amplitude components in amplifier 210 IM waves with respect to amplitude components when the amplifier 210 output signal has a linear characteristic. Similarly, FIG. 8 shows a case where, with regard to the relationship #802 between phase and power, amplifier 210 has linearity, and since amplifier 210 is actually nonlinear, it has the nonlinear characteristic of relationship #801 between phase and power. Therefore, compensation data table 204 stores, as compensation data, relationship #803 between amplitude and power symmetrical with relationship #801 between amplitude and power that the actual signal after amplitude has with respect to relationship #802 between amplitude and power when amplifier 210 has a linear characteristic. By this means, compensation data phase components become phase components of inverse phase to the phase components in amplifier 210 IM waves with respect to phase components when the amplifier 210 output signal has a linear characteristic.

Next, a description will be given of the operation of transmitting apparatus 200 in a distortion component suppression operation that suppresses IM waves #501, #502, #503, #504, #505, and #506 shown in FIG. 5.

A baseband signal is input to power calculation section 203 and complex multiplication section 205 as orthogonal data composed of an I component and a Q component. Power calculation section 203 calculates power from the input baseband signals. Then, in compensation data table 204, compensation data is referenced using measured power information and a compensation signal phase component is found, and also compensation data is referenced using measured power information and a compensation signal amplitude component is found. At this time, the relationship between amplitude and power stored by compensation data table 204 is that shown in FIG. 7, and the relationship between phase and power stored by compensation data table 204 is that shown in FIG. 8. Then compensation data table 204 finds a compensation signal using the phase components of the found phase and the amplitude components of the found amplitude, and outputs this compensation signal to complex multiplication section 205. The compensation signal is found as a vector from the phase and amplitude components.

Then IM waves #501, #502, #503, #504, #505, and #506, which are distortion components generated when the baseband signal is amplified by amplifier 210, are suppressed by combining the compensation signal and baseband signal in complex multiplication section 205.

Thus, according to Embodiment 1, distortion components generated when a baseband signal is actually amplified are found as a frequency axis series, and also the found frequency axis series is subjected to IFFT processing and converted to a time axis series, and a compensation table of the time of compensation signal generation is created, so that by generating a distortion compensation signal based on distortion components actually generated in a baseband signal, a compensation signal that takes account of frequency characteristics can be generated, and distortion components can be suppressed with high precision. Also, according to Embodiment 1, demodulation processing and so forth is rendered unnecessary and the circuit configuration can be made small and simple, and furthermore processing can be simplified and speeded up.

### Embodiment 2

FIG. 9 is a block diagram showing the configuration of a transmitting apparatus 900 according to Embodiment 2 of the present invention.

As shown in FIG. 9, in transmitting apparatus 900 according to Embodiment 2, as compared with transmitting apparatus 200 according to Embodiment 1 shown in FIG. 2, a table switching section 903 is added, and a compensation data up table 901 and a compensation data down table 902 are provided instead of compensation data table 204. Parts in FIG. 9 identical to those in FIG. 2 are assigned the same codes as in FIG. 2, and descriptions thereof are omitted.

In FIG. 9, transmitting apparatus 900 is mainly composed of input terminal 201, input terminal 202, power calculation section 203, complex multiplication section 205, DAC 206, DAC 207, oscillator 208, MOD 209, amplifier 210, antenna 211, compensation data up table 901, compensation data down table 902, and table switching section 903.

Input terminals 201 and 202, power calculation section 203, complex multiplication section 205, DAC 206, DAC 207, oscillator 208, MOD 209, amplifier 210, compensation data up table 901, compensation data down table 902, and table switching section 903 make up a distortion compensation apparatus 904. For distortion compensation apparatus 904 in FIG. 9, a predistortion distortion compensation apparatus configuration is shown, with power calculation section 203, complex multiplication section 205, compensation data up table 901, compensation data down table 902, and table switching section 903 forming a predistortion function.

Compensation data up table 901 is a data table for performing linear compensation of the amplifier, which has nonlinear characteristics, and holds vector value information. Compensation data up table 901 outputs a compensation signal in which amplitude component and phase component compensation information (rising-time compensation signal generation information) selected by referencing compensation data using measured power information input from power calculation section 203 is held as a vector value, to complex multiplication section 205.

Compensation data down table 902 is a data table for performing linear compensation of the amplifier, which has nonlinear characteristics, and holds vector value information. Compensation data down table 902 outputs a compensation signal in which amplitude component and phase component compensation information (falling-time compensation signal generation information) selected by referencing compensation data using measured power information input from power calculation section 203 is held as a vector value, to complex multiplication section 205.

Table switching section 903 determines from measured power information for different times input from power calculation section 203 whether measured power according to the latest measured power information has risen or fallen from past measured power. Then, if the latest measured power has risen from past measured power, table switching section 903 outputs the compensation signal input from compensation data up table 901 to complex multiplication section 205. On the other hand, if the latest measured power has fallen from past measured power, table switching section 903 outputs the compensation signal input from compensation data down table 902 to complex multiplication section 205.

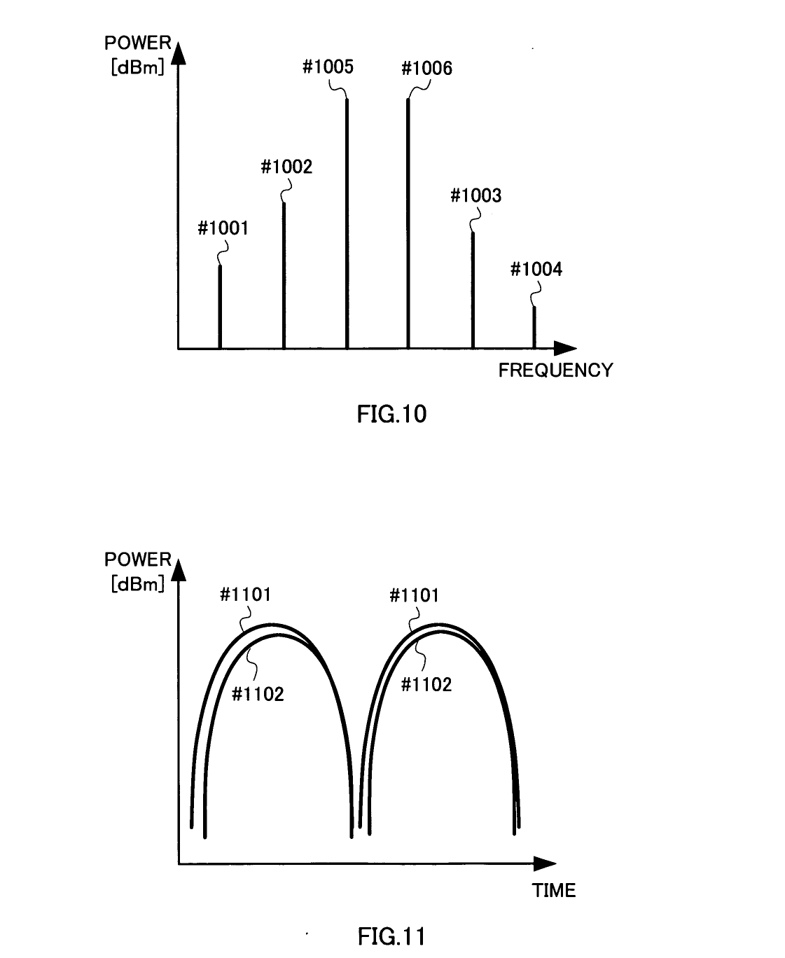

Next, the method of creating the compensation tables used in compensation data up table 901 and compensation data down table 902 will be described using FIG. 10 through FIG. 15. The compensation tables are created before a distortion component suppression operation. As the compensation table creation method flow chart is identical to that in FIG. 3, and the figure showing the pre-amplification baseband signal as a frequency series is identical to FIG. 4, FIG. 3 and FIG. 4 will be used in the following description.

First, as shown in FIG. 4, a two-wave signal comprising two waves, fundamental #401 and fundamental #402, is input to amplifier 210 (step ST301).

Next, the input two-wave signal is amplified by amplifier 210, and the fundamentals and IM waves in the amplified two-wave signal are measured by means of a vector signal analyzer (step ST302). By this means, the fundamentals and IM waves can be obtained as vector values on the frequency axis, and can be obtained not only as power values (amplitude values) but also as phase values. Vector measurement can be carried out by any method, not only by using a vector signal analyzer.

Next, based on the measurement results, the fundamental phase difference of the two-wave signal is corrected so that the fundamental phase difference becomes 0 degrees (step ST303). Also, correction is performed so that the phase difference of the input two-wave signal becomes 0 degrees (step ST303).

Then, as shown in FIG. 10, IM waves reflecting these corrections are plotted as a frequency axis series (f-dat-out) (step ST304). By amplifying the input two-wave signal, IM waves #1001, #1002, #1003, and #1004 are generated in addition to fundamentals #1005 and #1006. IM waves #1001, #1002, #1003, and #1004 are generated as distortion components of fundamentals #1005 and #1006, and the further these IM waves are from fundamentals #1005 and #1006 on the frequency axis, the smaller is their power. The power levels of IM wave #1002 and IM wave #1003 detected at symmetrical positions on the frequency axis with respect to fundamentals #1005 and #1006 are different, and the power levels of IM wave #1001 and IM wave #1004 detected at symmetrical positions on the frequency axis with respect to fundamentals #1005 and #1006 are different. Plotting is also performed as a frequency axis series (f-dat-in) for an input two-wave signal subjected to phase correction (step ST304).

Next, IM waves#1001, #1002, #1003, and #1004 plotted as frequency axis series (f-dat-out) are subjected to IFFT processing, and converted to a time axis series (t-dat-out) (step ST305). FIG. 11 shows an output signal and input signal converted to a time axis series as power values. As shown in FIG. 11, relationship #1102 between time and power in an actual amplifier 210 output signal is distorted with respect to relationship #1101 between time and power when a amplifier 210 output signal in which distortion has not occurred has undergone IFFT processing, due to the fact that the power of IM wave #1002 and the power of IM wave #1003 differ and the power of IM wave #1001 and the power of IM wave #1004 differ.

Then an amplifier 210 transfer function is obtained from the obtained amplifier input signal and output signal frequency axis series using Equation (1) (step ST306) Also, amplifier 210 transfer function AMP(t) expressed by a time function is converted to input signal power function AMP(P) using Equation (2) (step ST307).

It is then determined whether or not the predetermined number of measurements by means of the vector signal analyzer have finished (step ST308) If the predetermined number of measurements have finished, the measurement results are combined and transfer function AMP(P) is found using Equation (5).

Next, a transfer function is found that has an amplitude component of inverse amplitude to the amplitude component in the amplifier 210 transfer function found from Equation (5) and a phase component of inverse phase to the phase component in the amplifier 210 transfer function found from Equation (5) with respect to an amplitude component and phase component when the amplifier 210 output signal has a linear characteristic, and the found transfer function is converted and stored as a compensation table (step ST309). At this time, a compensation table is stored separately for the case where amplifier 210 input power is on an upward trend and the case where amplifier 210 input power is on a downward trend.

On the other hand, if the predetermined number of measurements have not finished in step ST308, the processing from step ST301 through step ST307 is repeated until the predetermined number of measurements have finished.

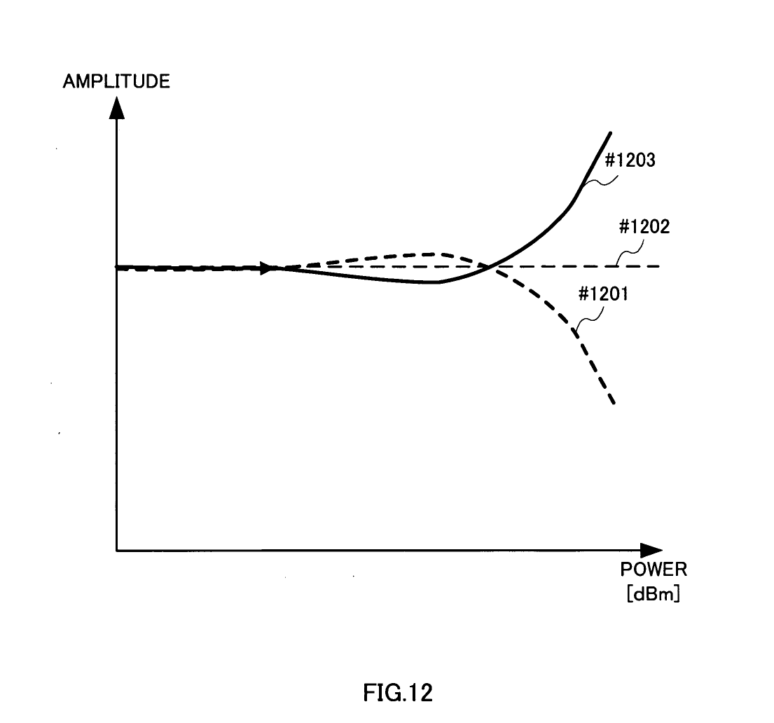

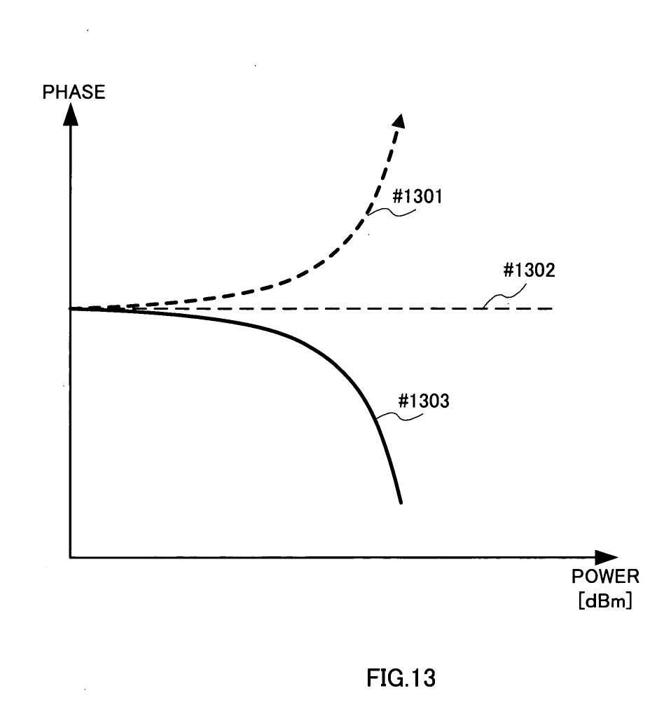

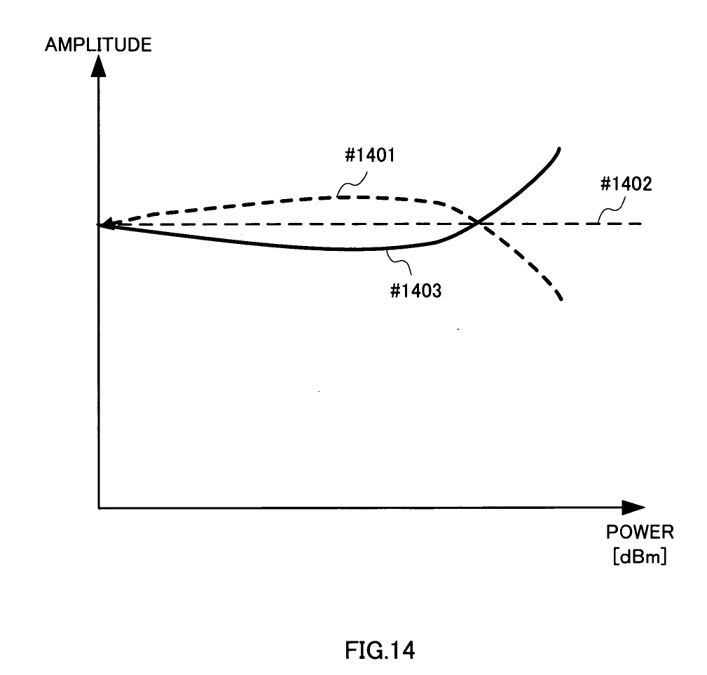

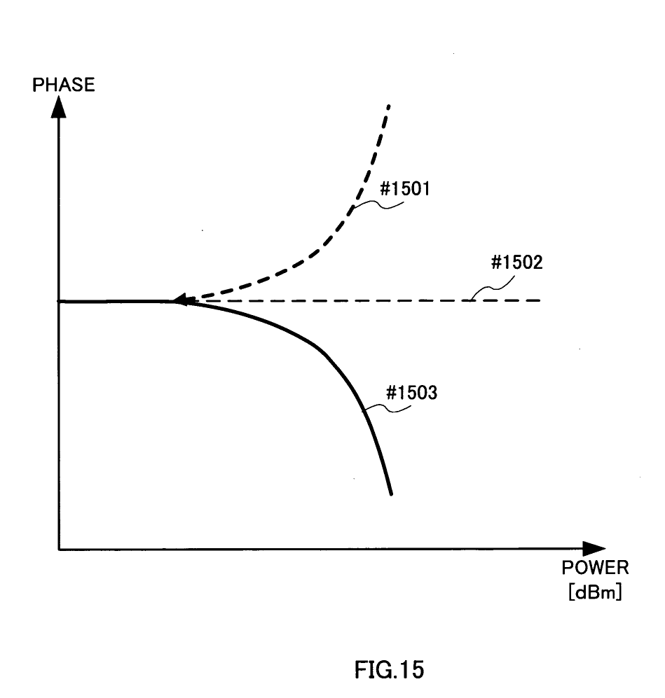

FIG. 12 is a drawing showing the relationship between compensation data power and amplitude in compensation data up table 901, FIG. 13 is a drawing showing the relationship between compensation data power and phase in compensation data up table 901, FIG. 14 is a drawing showing the relationship between compensation data power and amplitude in compensation data down table 902, and FIG. 15 is a drawing showing the relationship between compensation data power and phase in compensation data down table 902.

FIG. 12 shows a case where, with regard to relationship #1202 between amplitude and power, amplifier 210 has linearity, and since amplifier 210 is actually nonlinear, it has the nonlinear characteristic of relationship #1201 between amplitude and power. Therefore, compensation data up table 1001 stores, as compensation data, relationship #1203 between amplitude and power symmetrical with relationship #1201 between amplitude and power that the actual signal after amplitude has with respect to relationship #1002 between amplitude and power when amplifier 210 has linearity.

Similarly, FIG. 13 shows a case where, with regard to relationship #1302 between phase and power, amplifier 210 has linearity, and since amplifier 210 is actually nonlinear, it has the nonlinear characteristic of relationship #1301 between phase and power. Therefore, compensation data up table 1001 stores, as compensation data, relationship #1303 between amplitude and power symmetrical with relationship #1301 between amplitude and power that the actual signal after amplitude has with respect to relationship #1302 between amplitude and power when amplifier 210 has linearity.

FIG. 14 shows a case where, with regard to relationship #1402 between amplitude and power, amplifier 210 has linearity, and since amplifier 210 is actually nonlinear, it has the nonlinear characteristic of relationship #1401 between amplitude and power. Therefore, compensation data down table 1002 stores, as compensation data, relationship #1403 between amplitude and power symmetrical with relationship #1401 between amplitude and power that the actual signal after amplitude has with respect to relationship #1402 between amplitude and power when amplifier 210 has linearity.

Similarly, FIG. 15 shows a case where, with regard to relationship #1502 between phase and power, amplifier 210 has linearity, and since amplifier 210 is actually nonlinear, it has the nonlinear characteristic of relationship #1501 between phase and power. Therefore, compensation data down table 1002 stores, as compensation data, relationship #1503 between amplitude and power symmetrical with relationship #1501 between amplitude and power that the actual signal after amplitude has with respect to relationship #1502 between amplitude and power when amplifier 210 has linearity. By this means, compensation data amplitude components become amplitude components of inverse amplitude to amplitude components in amplifier 210 IM waves with respect to amplitude components when the amplifier 210 output signal has a linear characteristic. Also, compensation data amplitude components become amplitude components of inverse amplitude to amplitude components in amplifier 210 IM waves with respect to amplitude components when the amplifier 210 output signal has a linear characteristic.

Next, a description will be given of the operation of transmitting apparatus 900 in a distortion component suppression operation that suppresses IM waves #1001, #1002, #1003, and #1004 shown in FIG. 10.

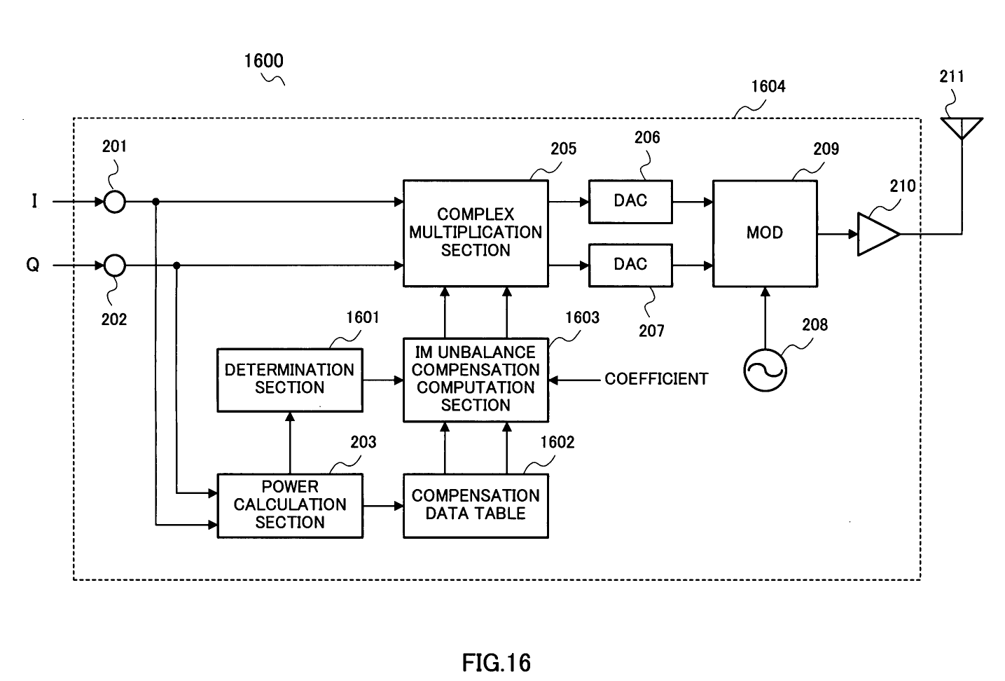

A baseband signal is input to power calculation section 203 and complex multiplication section 205 as orthogonal data composed of an I component and a Q component. Power calculation section 203 calculates power from the input baseband signals. Then, in compensation data up table 901 and compensation data down table 902, compensation data is referenced using measured power information and a compensation signal phase component is found, and also compensation data is referenced using measured power information and a compensation signal amplitude component is found. At this time, the relationship between amplitude and power stored by compensation data up table 901 is that shown in FIG. 13, and the relationship between phase and power stored by compensation data up table 901 is that shown in FIG. 14. Also, the relationship between amplitude and power stored by compensation data down table 902 is that shown in FIG. 15, and the relationship between phase and power stored by compensation data down table 902 is that shown in FIG. 16. Table switching section 903 then determines whether baseband signal power is on an upward trend or on a downward trend, and outputs the compensation signal input from compensation data up table 901 to complex multiplication section 205 if power is on an upward trend, or outputs the compensation signal output from compensation data down table 902 to complex multiplication section 205 if power is on a downward trend. The compensation signal is found as a vector from the phase and amplitude components.

Then IM waves #1001, #1002, #1003, and #1004, which are distortion components generated when the baseband signal is amplified by amplifier 210, are suppressed by combining the compensation signal and baseband signal in complex multiplication section 205.

Thus, according to Embodiment 2, in addition to provision of the effects of above-described Embodiment 1, IM waves can be suppressed using different compensation data when baseband signal power is on an upward trend and when baseband signal power is on a downward trend, enabling IM waves also to be suppressed with high precision in a case where lower/upper unbalance occurs whereby power differs between low-frequency-side distortion components and high-frequency-side distortion components on the frequency axis generated in a signal amplified by power amplifier 210 due to temperature characteristics, for example. Also, according to Embodiment 2, compensation table creation is performed taking account of lower/upper unbalance frequency characteristics, enabling a satisfactory suppression effect to be obtained for IM waves generated during input to a multicarrier amplifier.

### Embodiment 3

FIG. 16 is a block diagram showing the configuration of a transmitting apparatus 1600 according to Embodiment 3 of the present invention.

As shown in FIG. 16, in transmitting apparatus 1600 according to Embodiment 3, as compared with transmitting apparatus 200 according to Embodiment 1 shown in FIG. 2, a compensation data table 1602 is provided instead of compensation data table 204, and determination section 1601 and an IM unbalance compensation computation section 1603 are added. Parts in FIG. 16 identical to those in FIG. 2 are assigned the same codes as in FIG. 2, and descriptions thereof are omitted.

In FIG. 16, transmitting apparatus 1600 is mainly composed of input terminal 201, input terminal 202, power calculation section 203, complex multiplication section 205, DAC 206, DAC 207, oscillator 208, MOD 209, amplifier 210, antenna 211, determination section 1601, compensation data table 1602, and IM unbalance compensation computation section 1603.

Input terminal 201, input terminal 202, power calculation section 203, complex multiplication section 205, DAC 206, DAC 207, oscillator 208, MOD 209, amplifier 210, determination section 1601, compensation data table 1602, and IM unbalance compensation computation section 1603 make up a distortion compensation apparatus 1604. For distortion compensation apparatus 1604 in FIG. 16, a predistortion distortion compensation apparatus configuration is shown, with power calculation section 203, complex multiplication section 205, determination section 1601, compensation data table 1602, and IM unbalance compensation computation section 1603 forming a predistortion function.

Using at least two items of measured power information in the measured power information for each sampling time input from power calculation section 203, determination section 1601 determines whether measured power according to the latest measured power information is rising or falling in comparison with measured power according to past measured power information, and outputs the determination result to IM unbalance compensation computation section 1603.

Compensation data table 1602 has vector information comprising a data table of amplifier 210 that has nonlinear characteristics. Then compensation data table 1602 outputs amplifier 210 nonlinear characteristic information to IM unbalance compensation computation section 1603 based on power information input from power calculation section 203 and a nonlinearity information table that has vector information. The method of creating the nonlinearity information table will be described later herein.

IM unbalance compensation computation section 1603 generates, and stores as a compensation table, a compensation signal based on nonlinear characteristic information found at at least two different times input from compensation data table 1602 before a distortion compensation operation, a coefficient, the result of determination by determination section 1601 as to whether measured power is on an upward trend or on a downward trend, and a fixed value when amplifier 210 is assumed to have linear characteristics—that is, when amplifier 210 performs fixed transmission operation regardless of input power. IM unbalance compensation computation section 1603 then references the compensation table using measured power information input from determination section 1601 at the time of a distortion component compensation operation and selects a compensation signal, and outputs the selected compensation signal to complex multiplication section 205.

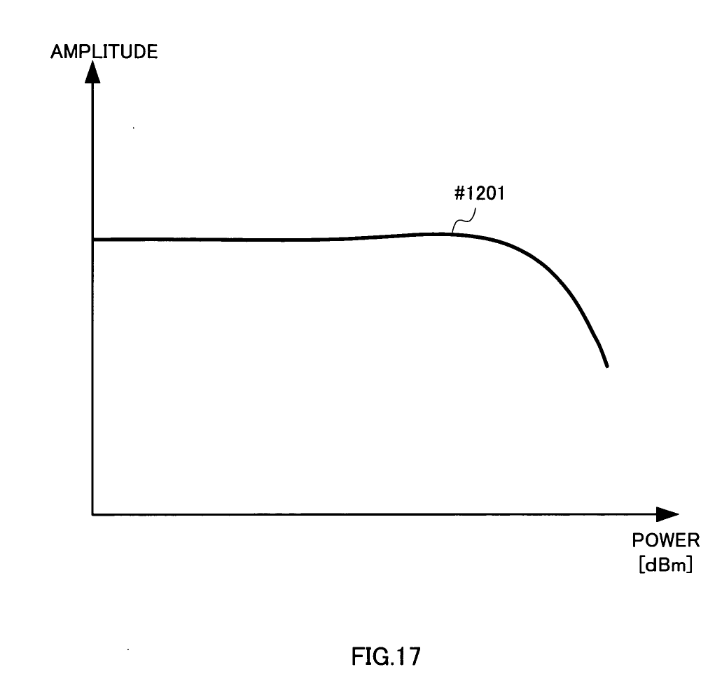

Next, the method of creating the nonlinearity information table used by compensation data table 1602 and the compensation table used by IM unbalance compensation computation section 1603 will be described using FIG. 17 through FIG. 24. The nonlinearity information table and compensation table are created in advance prior to a distortion component suppression operation.

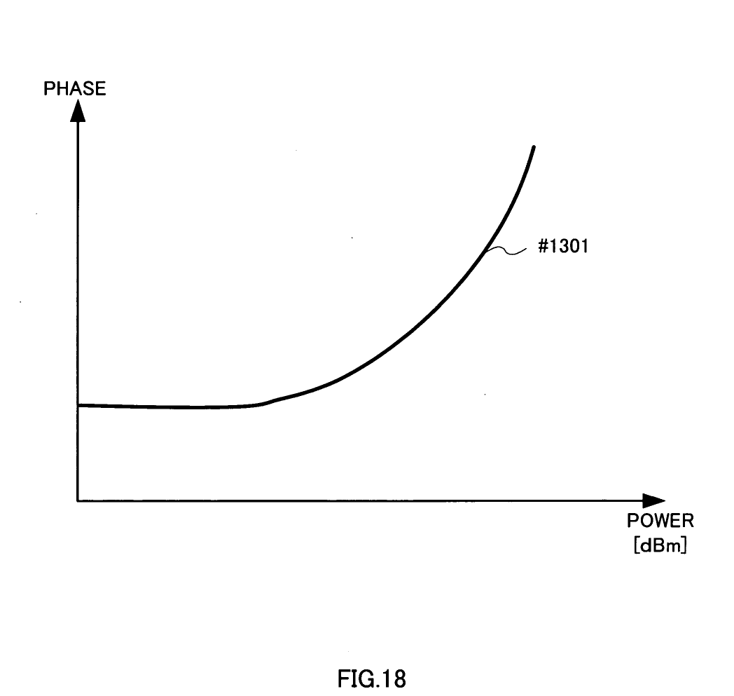

A baseband signal is input to power calculation section 203 and complex multiplication section 205 as orthogonal data composed of an I component and a Q component. Power calculation section 203 calculates power from the input base band signals. Then compensation data table 204 outputs amplifier 210 nonlinear characteristic information to IM unbalance compensation computation section 1603. At this time, compensation data table 204 stores the relationship between amplitude and power shown in FIG. 17. Also, compensation data table 204 stores the relationship between phase and power shown in FIG. 18.

Here, the relationship between amplitude and power shown in FIG. 17 is identical to relationship #1201 between amplitude and power in FIG. 12, and the relationship between phase and power shown in FIG. 18 is identical to relationship #1301 between amplitude and power in FIG. 13. That is to say, compensation data table 1602 stores the relationship between amplitude and power shown in FIG. 17 and the relationship between phase and power shown in FIG. 18 found by a method identical to the method up to finding relationship #1201 between amplitude and power and relationship #1301 between amplitude and power in above-described Embodiment 2 as nonlinear characteristic information.

When performing computational processing to show the unbalance IM characteristic, IM unbalance compensation computation section 1603 finds the unbalance IM characteristic based on compensation data at time t-1 input from compensation data table 204, compensation data at time t after the elapse of a predetermined time from time t-1 input from compensation data table 204, a coefficient, the result of determination by determination section 1601 as to whether measured power is on an upward trend or on a downward trend, and a fixed value.

Specifically, the unbalance IM characteristic can be found using Equation (6) or Equation (7).
Real_amp(t)=amp(t)+(amp(t)−amp(t-1))×(Li_amp−amp(t-1))×g (6)
Real_amp(t)=amp(t)−(amp(t)−amp(t-1))×(Li_amp−amp(t-1))×g (7)
where

Real_amp(t): Unbalance IM characteristic at time t

amp(t): Compensation data at time t

amp(t-1): Compensation data at time t-1

Li_amp: Fixed value

g: Coefficient

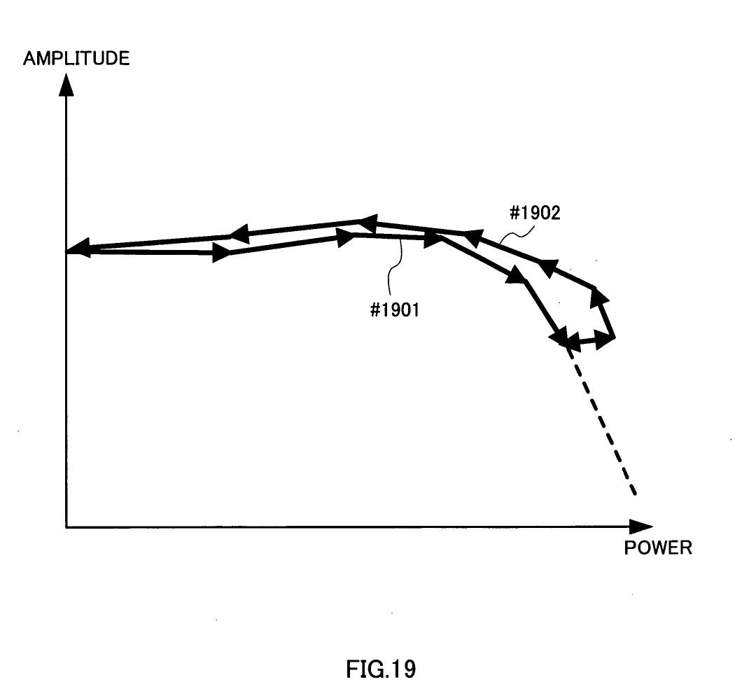

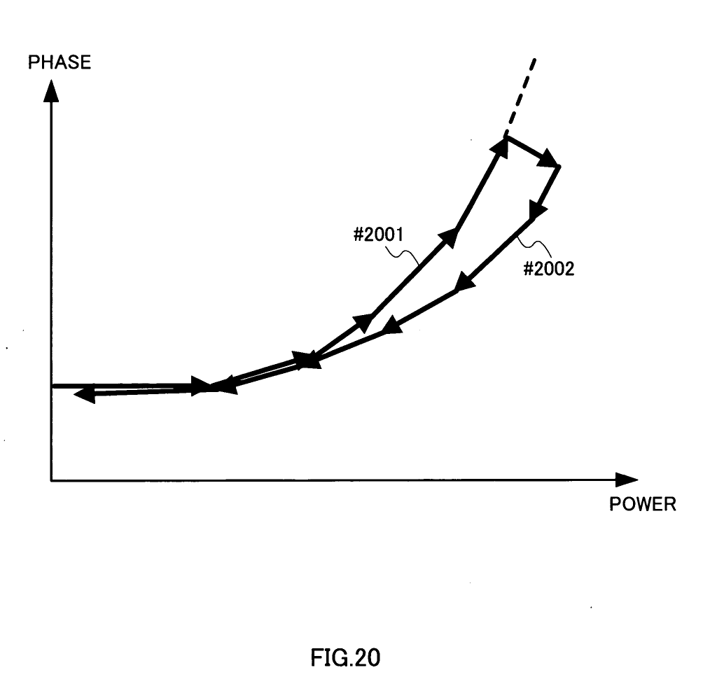

In this way, IM unbalance compensation computation section 1603 finds the unbalance IM characteristic shown in FIG. 19 from the amplifier 210 nonlinear characteristic shown in FIG. 17, and also finds the unbalance IM characteristic shown in FIG. 20 from the amplifier 210 nonlinear characteristic shown in FIG. 18. As shown in FIG. 19, the relationship between amplitude and power in the unbalance IM characteristic has hysteresis whereby the relationship #1901 between power and amplitude when power is on an upward trend and the relationship #1902 between power and amplitude when power is on a downward trend follow different paths. Also, as shown in FIG. 20, the relationship between phase and power in the unbalance IM characteristic has hysteresis whereby the relationship #2001 between power and phase when power is on an upward trend and the relationship #2002 between power and phase when power is on a downward trend follow different paths. Relationships between power and amplitude and between power and phase that have hysteresis of this kind can be changed by setting coefficient g in Equation (6) and Equation (7) variably.

Next, when IM unbalance compensation computation section 1603 converts an unbalance IM characteristic to a compensation characteristic and generates a compensation signal, IM unbalance compensation computation section 1603 performs conversion to a compensation characteristic so that there is symmetry with the unbalance IM characteristic with respect to a fixed value at which amplitude and phase become almost fixed when amplifier 210 is assumed to have a linear characteristic. Specifically, the compensation characteristic is obtained from Equation (8) using the unbalance IM characteristic and linear characteristic found from Equation (6) or Equation (7).
Compensation characteristic=Li_amp/Real_amp (8)
where

Real_amp: Unbalance IM characteristic

Li_amp: Fixed value

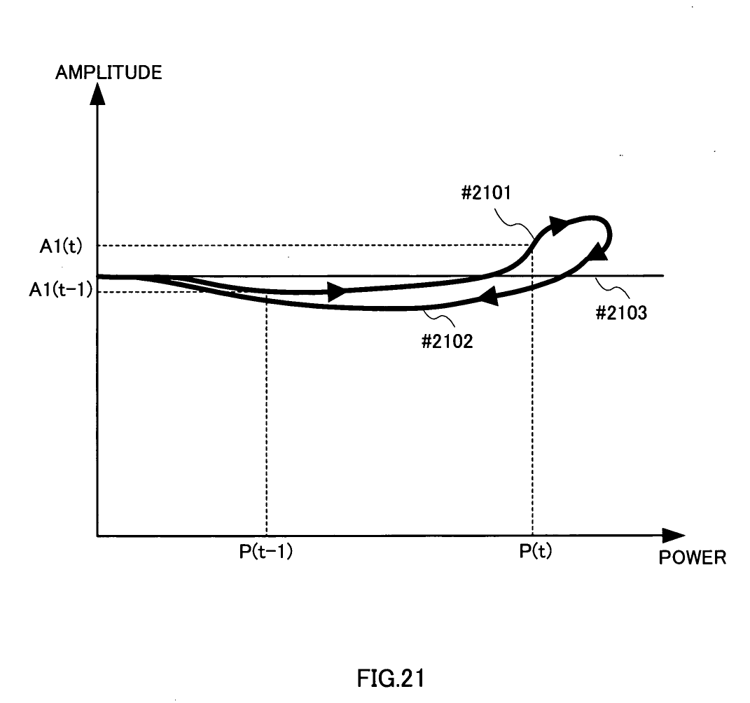

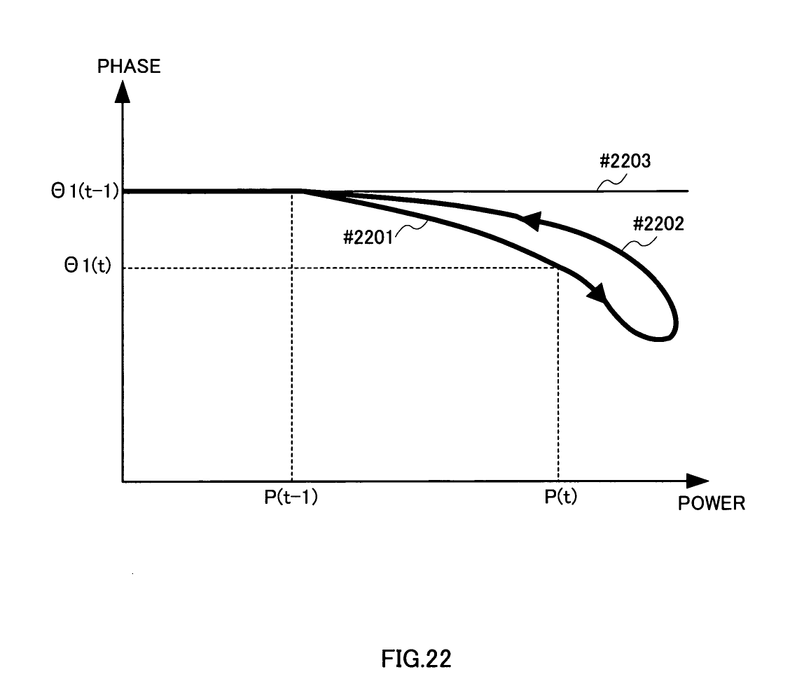

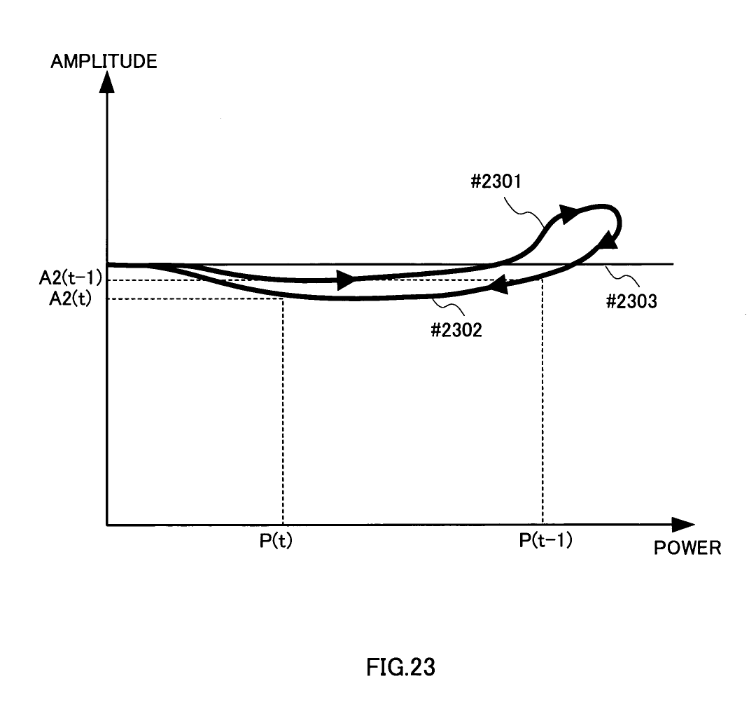

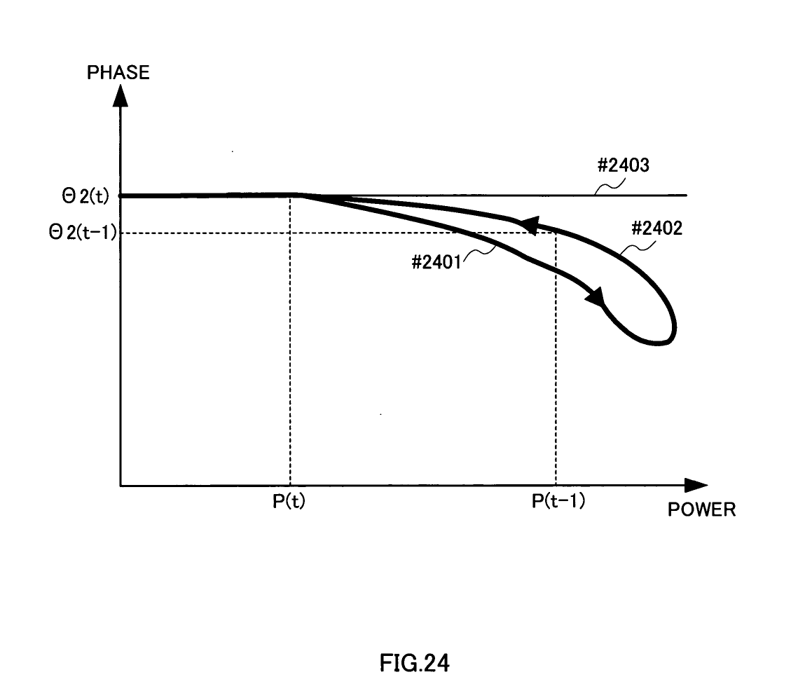

In this way, IM unbalance compensation computation section 1603 converts the hysteresis characteristics shown in FIG. 19 and FIG. 20 to the compensation characteristics shown in FIG. 21 and FIG. 23. FIG. 21 and FIG. 23 are drawings showing the relationship between amplitude components and power in compensation characteristics, and FIG. 22 and FIG. 24 are drawings showing the relationship between phase components and power in compensation characteristics.

By converting an unbalance IM characteristic to a compensation characteristic, when input power is on an upward trend, relationship #1901 between amplitude and power is converted to a relationship #2101 between amplitude and power, and relationship #2001 between phase and power is converted to a relationship #2201 between phase and power. Also, by converting an unbalance IM characteristic to a compensation characteristic, when input power is on a downward trend, relationship #1902 between amplitude and power is converted to a relationship #2102 between amplitude and power, and relationship #2002 between phase and power is converted to a relationship #2202 between phase and power. IM unbalance compensation computation section 1603 stores compensation characteristics by storing the relationships between amplitude and power and the relationships between phase and power shown in FIG. 21 through FIG. 24 in a compensation table as vector information.

Here, the data table stored by IM unbalance compensation computation section 1603 is stored as vector information, and the vector information has amplitude information and phase information. Therefore, IM unbalance compensation computation section 1603 has amplitude and phase components corresponding to power P input to amplifier 210 as a compensation data table. That is to say, the relationship between an input signal to amplifier 210 and an output signal from amplifier 210 is expressed as shown in Equation (9).
Output signal=amp×input signal (9)
where amp: Amplifier characteristic

Also, amplifier characteristic amp is expressed as shown in Equation (10).
amp(P)=A(P)×e^{-jθ(P)} (10)
where

A(P): Amplitude component at time t

θ(P): Phase component at time t

P: Power input to amplifier 210

amp(P): Amplifier 210 characteristic

Therefore, the amplifier 210 characteristic can be found as an amplitude component and phase component from Equation (10).

A description will now be given, using FIG. 21 through FIG. 24, of the operation of transmitting apparatus 1600 in a distortion component suppression operation that suppresses IM waves #1001, #1002, #1003, and #1004 when IM waves #1001, #1002, #1003, and #1004 shown in FIG. 10 are generated.

If measured power P(t) at time t has risen above measured power P(t-1) at time t-1 according to determination section 1601, IM unbalance compensation computation section 1603 determines that measured power is on an upward trend, selects A1(t-1) as the amplitude component of measured power P(t-1) at time t-1 and selects A1(t) as the amplitude component of measured power P(t) at time t from FIG. 21, and also selects θ1(t-1) as the phase component of measured power P(t-1) at time t-1 and selects θ1(t) as the phase component of measured power P(t) at time t from FIG. 22. IM unbalance compensation computation section 1603 then outputs a compensation signal that has compensation characteristics for the selected amplitude and phase components. The fixed value here is found from relationship #2103 between amplitude and power in which amplitude becomes almost fixed as shown in FIG. 21 and relationship #2203 between phase and power in which phase becomes almost fixed as shown in FIG. 22.

On the other hand, if measured power P(t) at time t has fallen below measured power P(t-1) at time t-1 according to determination section 1601, IM unbalance compensation computation section 1603 determines that measured power is on a downward trend, selects A2(t-1) as the amplitude component of measured power P(t-1) at time t-1 and selects A2(t) as the amplitude component of measured power P(t) at time t from FIG. 23, and also selects θ2(t-1) as the phase component of measured power P(t-1) at time t-1 and selects θ2(t) as the phase component of measured power P(t) at time t from FIG. 24. IM unbalance compensation computation section 1603 then outputs a compensation signal that has compensation characteristics for the selected amplitude and phase components. The fixed value here is found from relationship #2303 between amplitude and power in which amplitude becomes almost fixed as shown in FIG. 23 and relationship #2403 between phase and power in which phase becomes almost fixed as shown in FIG. 24.

Next, complex multiplication section 205 suppresses IM waves #1001, #1002, #1003, and #1004 comprising distortion components in FIG. 10 by combining the baseband signal and compensation signal.

Thus, according to Embodiment 3, baseband signal distortion components generated when a baseband signal is actually amplified are found as a frequency axis series, the found frequency axis series is subjected to IFFT processing and converted to a time axis series, and is held in compensation data table 1602 as amplifier 210 nonlinear characteristic information, so that by generating a distortion compensation signal based on distortion components actually generated in a baseband signal, a compensation signal that takes account of frequency characteristics can be generated, and distortion components can be suppressed with high precision. Also, according to Embodiment 3, demodulation processing and so forth is rendered unnecessary and the circuit configuration can be made small and simple, and furthermore processing can be simplified and speeded up. Moreover, according to Embodiment 3, IM waves are suppressed after finding a compensation signal that has different amplitude and phase components when measured power is on an upward trend and when measured power is on a downward trend by correcting amplifier 210 nonlinear characteristic information, enabling distortion components in a state of lower/upper unbalance to be suppressed with high precision.

In above Embodiments 1 through 3, IM waves generated when a two-wave input signal is amplified are suppressed, but this is not a limitation, and the present invention can also be applied to a case where IM waves generated when a single-wave input signal or an input signal of three or more waves is amplified are suppressed.

As described above, according to the present invention the circuit configuration can be made small and simple, processing can be simplified and speeded up, and distortion components can be suppressed with high precision.

This application is based on Japanese Patent Application No. 2002-365448 filed on Dec. 17, 2002, the entire content of which is expressly incorporated by reference herein.

### INDUSTRIAL APPLICABILITY

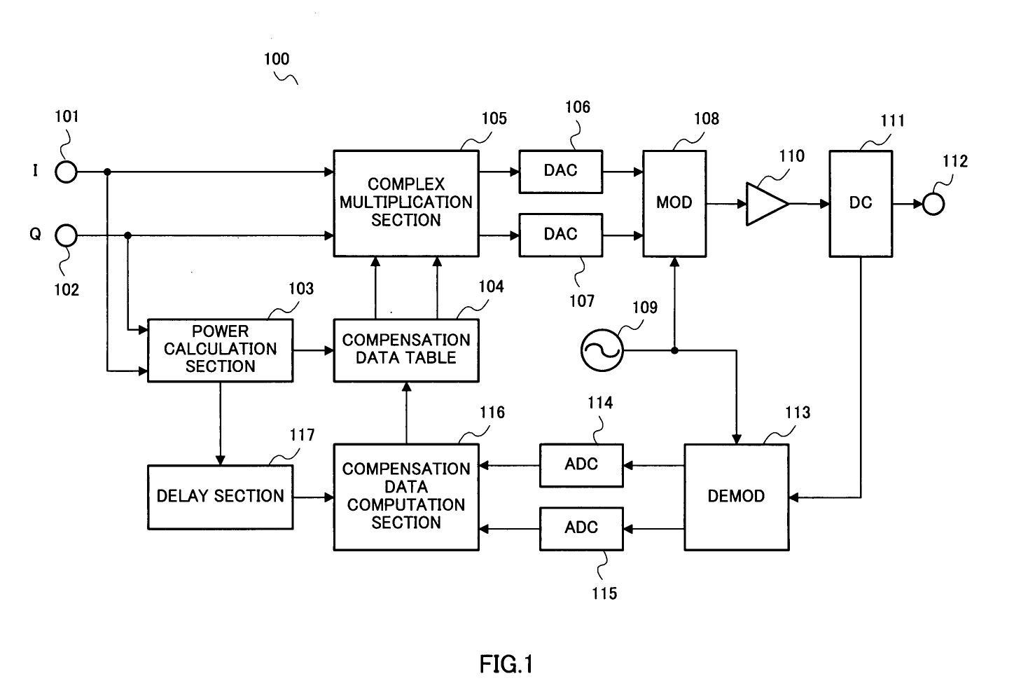

The present invention relates to a distortion compensation table creation method and distortion compensation method, and is suitable for use, for example, in a distortion compensation table creation method and distortion compensation method that eliminate distortion generated when a signal is amplified.

[FIG. 1]

103 POWER CALCULATION SECTION
104 COMPENSATION DATA TABLE
105 COMPLEX MULTIPLICATION SECTION
116 COMPENSATION DATA COMPUTATION SECTION
117 DELAY SECTION
   [FIG. 2]
203 POWER CALCULATION SECTION
304 COMPENSATION DATA TABLE
405 COMPLEX MULTIPLICATION SECTION
   [FIG. 3]
START
ST301 SIGNAL INPUT
ST302 FUNDAMENTAL AND IM WAVE MEASUREMENT
ST303 PHASE DIFFERENCE CORRECTION
ST304 PLOT SIGNALS ON FREQUENCY AXIS
ST306 FIND TIME t TRANSFER FUNCTION
ST307 CONVERT TO POWER P TRANSFER FUNCTION
ST308 END OF PREDETERMINED NUMBER OF TIMES?
ST309 COMPENSATION TABLE CREATION END
   [FIG. 4]
POWER
FREQUENCY
   [FIG. 5]
POWER
FREQUENCY
   [FIG. 6]
POWER
TIME
   [FIG. 7]
AMPLITUDE
POWER
   [FIG. 8]
PHASE
POWER
   [FIG. 9]
203 POWER CALCULATION SECTION
205 COMPLEX MULTIPLICATION SECTION
901 COMPENSATION DATA UP TABLE
902 COMPENSATION DATA DOWN TABLE
903 TABLE SWITCHING SECTION
   [FIG. 10]
POWER
FREQUENCY
   [FIG. 11]
POWER
TIME
   [FIG. 12]
AMPLITUDE
POWER
   [FIG. 13]
PHASE
POWER
   [FIG. 14]
AMPLITUDE
POWER
   [FIG. 15]
PHASE
POWER
   [FIG. 16]
203 POWER CALCULATION SECTION
205 COMPLEX MULTIPLICATION SECTION
1601 DETERMINATION SECTION
1602 COMPENSATION DATA TABLE
1603 IM UNBALANCE COMPENSATION COMPUTATION SECTION COEFFICIENT
   [FIG. 17]
AMPLITUDE
POWER
   [FIG. 18]
PHASE
POWER
   [FIG. 19]
AMPLITUDE
POWER
   [FIG. 20]
PHASE
POWER
   [FIG. 21]
AMPLITUDE
POWER
   [FIG. 22]
PHASE
POWER
   [FIG. 23]
AMPLITUDE
POWER
   [FIG. 24]
PHASE
POWER

1. A distortion compensation table creation method comprising:
a step of finding a distortion component generated in an amplified signal when a baseband signal is amplified by relating frequency to power of said baseband signal;
a step of converting said distortion component found by relating frequency to said power so as to be related to time and said power;
a step of finding an amplitude component and phase component in found said distortion component converted so as to be related to time and said power for each said power;
a step of finding a distortion compensation signal that has an amplitude component whereby an amplitude component in found said distortion component is an inverse amplitude with respect to an amplitude component of said amplified signal when said distortion component is not present and a phase component whereby a phase component in said distortion component is an inverse phase with respect to a phase component of said amplified signal when said distortion component is not present; and
a step of relating found said distortion compensation signal and said power and performing storage in a table as compensation signal generation information for selecting said distortion compensation signal that suppresses said distortion component.

2. The distortion compensation table creation method according to claim 1, further comprising:
a step of relating said power to said distortion compensation signal when current said power is rising with respect to past said power and performing generation as rising-time compensation signal generation information;
a step of relating said power to said distortion compensation signal when current said power is falling with respect to past said power and performing generation as falling-time compensation signal generation information; and
a step of storing said rising-time compensation signal generation information and said falling-time compensation signal generation information in a table as said compensation signal generation information.

3. A distortion compensation method comprising:
a step of finding a distortion component generated in an amplified signal resulting from amplifying a baseband signal with an amplifier by relating frequency to power of said baseband signal prior to a distortion component suppression operation;
a step of converting said distortion component found by relating frequency to said power so as to be related to time and said power;
a step of finding an amplitude component and phase component in said distortion component converted so as to be related to time and said power for each said power;
a step of finding a distortion compensation signal that has an amplitude component whereby an amplitude component in found said distortion component is an inverse amplitude with respect to an amplitude component of said amplified signal when said distortion component is not present and a phase component whereby a phase component in said distortion component is an inverse phase with respect to a phase component of said amplified signal when said distortion component is not present;
a step of relating found said distortion compensation signal and said power and performing storage in a table as compensation signal generation information for selecting said distortion compensation signal that suppresses said distortion component;
a step of measuring power of a baseband signal at a time of said distortion component suppression operation;
a step of selecting said distortion compensation signal by referencing said compensation signal generation information using information of measured said power;
a step of combining said baseband signal and selected said distortion compensation signal; and
a step of suppressing with said distortion compensation signal said distortion component generated by amplifying with said amplifier said baseband signal with which said distortion compensation signal has been combined.

4. The distortion compensation method according to claim 3, further comprising:
a step of relating said power to said distortion compensation signal when current said power is rising with respect to past said power and performing generation as rising-time compensation signal generation information;
a step of relating said power to said distortion compensation signal when current said power is falling with respect to past said power and performing generation as falling-time compensation signal generation information;
a step of storing said rising-time compensation signal generation information and said falling-time compensation signal generation information in a table as said compensation signal generation information;
a step of selecting said distortion compensation signal by referencing said rising-time compensation signal generation information using information of said power when measured said power of said baseband signal is on an upward trend, and selecting said distortion compensation signal by referencing said falling-time compensation signal generation information using information of said power when measured said power of said baseband signal is on a downward trend.

5. A transmitting method comprising:
a step of finding a distortion component generated in an amplified signal when a base band signal is amplified with an amplifier by relating frequency to power of said baseband signal prior to a distortion component suppression operation;
a step of converting said distortion component found by relating frequency to said power so as to be related to time and said power;
a step of finding an amplitude component and phase component in found said distortion component converted so as to be related to time and said power for each said power;
a step of finding a distortion compensation signal that has an amplitude component whereby an amplitude component in found said distortion component is an inverse amplitude with respect to an amplitude component of said amplified signal when said distortion component is not present and a phase component whereby a phase component in said distortion component is an inverse phase with respect to a phase component of said amplified signal when said distortion component is not present;
a step of relating found said distortion compensation signal and said power and performing storage in a table as compensation signal generation information;
a step of measuring transmission power of a baseband signal at a time of said distortion component suppression operation;
a step of selecting said distortion compensation signal by referencing said compensation signal generation information using information of measured said baseband signal power;
a step of combining said baseband signal and selected said distortion compensation signal;
a step of suppressing with said distortion compensation signal combined with said baseband signal said distortion component generated by amplifying with said amplifier said baseband signal with which said distortion compensation signal has been combined; and
a step of transmitting said baseband signal in which said distortion component has been suppressed by said distortion compensation signal.

6. The transmitting method according to claim 5, further comprising:
a step of relating said power to said distortion compensation signal when current said power is rising with respect to past said power and performing generation as rising-time compensation signal generation information;
a step of relating said power to said distortion compensation signal when current said power is falling with respect to past said power and performing generation as falling-time compensation signal generation information;
a step of storing said rising-time compensation signal generation information and said falling-time compensation signal generation information in a table as said compensation signal generation information; and
a step of selecting said distortion compensation signal by referencing said rising-time compensation signal generation information using information of said power when measured said power of said baseband signal is on an upward trend, and selecting said distortion compensation signal by referencing said falling-time compensation signal generation information using information of said power when measured said power of said baseband signal is on a downward trend.
